(19) United States
(12) Patent Application Publication
(10) Pub. No.: US 2004/0163173 A1
(43) Pub. Date: Aug. 26, 2004

(54) Extension device for patient lift

(75) Inventor: Fred Downing, White Bear Lake, MN (US)

Correspondence Address: BANNER & WITCOFF, LTD., TEN SOUTH WACKER DRIVE, SUITE 3000, CHICAGO, IL, 60606, US

(73) Assignee: EZ Way Inc., Minneapolis, MN

(21) Appl. No.: 10/758,062

(22) Filed: Jan. 15, 2004

Related U.S. Application Data
(60) Provisional application No. 60/440,197, filed on Jan. 15, 2003.

(51) Int. Cl. A61G 7/10

(52) U.S. Cl. 5/86.1; 5/89.1

(57) ABSTRACT

A boom extension for a patient lift device is attached to the boom arm of the patient lift device and functions to extend the cantilever support of a patient in a harness or sling which is attached to the boom extension of the patient lift device.

### CROSS REFERENCE TO RELATED APPLICATION

This is a utility patent application derived from and incorporating by reference previously filed provisional application Serial No. 60/440,197 filed Jan. 15, 2003 entitled Extension Device For Patient Lift, incorporated herewith by reference and for which priority is claimed.

### BACKGROUND OF THE INVENTION

In a principal aspect the present invention is an extension device for attachment to a patient lift device.

Personal lifts are used to move persons or patients who are immobile or are unable to rise from a seated or prone position. Without the use of a personal lift system, such patients need to be lifted by healthcare workers when being moved from one sitting area to another. Healthcare workers that cannot support the patient or lose their hold on the patient during lifting may cause the patient to fall and sustain an injury. Often such patients are of advanced age and have delicate skeletal structures which are prone to injury.

Additionally, healthcare workers may experience work related injuries when moving patients that are not mobile. For example, the healthcare worker may be in an awkward position when lifting an individual causing the worker to sustain muscular or back related injuries.

There have been a number of devices used to aid movement of patients to and from wheelchairs, chairs, beds and the like. Some of these devices are described and shown in the following U.S. patents which are incorporated herewith by reference.

PATENT NO. TITLE

5,305,773 Mobility Assist Device

5,441,044 Surgical Retractor

5,524,971 Seating And Back Systems For A Wheelchair

5,556,168 Wheelchair Back System

5,778,605 Glide Cap For Walker

5,785,070 Dual Handled Walking And Uprisal Assist Device

6,135,131 Adjustable Walker Handles

Des. 322,049 Articulated Three Wheel Vehicle

One particularly difficult situation involves lifting a patient into and out of a passenger car or vehicle. That is, the boom of most patient lift devices or systems does not extend sufficiently far to carry a person from a position outside of a vehicle to a desired position inside the vehicle and vice versa. Typically the patient needs to be disengaged from the lift system and physically carried in order to be positioned within the interior of the vehicle. This places the healthcare worker in an awkward position, and the patient or person being lifted in a potentially dangerous position since that person is being supported only by the healthcare worker.

Thus, there has developed a need for a patient lift device or system which can effectively transport a person into and out of a vehicle seat without undue exposure of the patient or the attendant healthcare worker to a hazardous or precarious situation.

### SUMMARY OF THE INVENTION

The present invention comprises a mechanism that can be attached to the boom of an existing patient lift system and thereby enable the placement of a person onto the seat of a vehicle without removing or disengaging the person from the lift system until that person is seated on the seat within the vehicle. Having this capability avoids placing a healthcare worker in an awkward position and also avoids placing the person being lifted in a potentially dangerous situation.

Briefly, the mechanism includes a boom extension which is easily fastened to the cantilever patient boom support arm of a patient lift device to thereby effectively extend the range of the patient boom support arm. With the extended length of the patient boom support arm, the patient may be positioned in a sling supported at the outer end of the boom extension.

When so supported, the patient may be easily positioned over and onto a seat in a vehicle. In a preferred embodiment, the extension boom comprises generally parallel spaced elongate plates or brackets that are connected by a pair of fasteners that fit against the patient boom support arm to retain the boom extension on the support arm.

Thus, it is an object of the invention to provide a mechanism or device which effectively extends the length of the patient support arm so as to enable ease of transport and placement of a person or patient into or out of a vehicle seat.

It is a further object of the invention to provide a mechanism to effectively extend the operational extent of the patient support arm of pre-existing patient support devices.

Another object of the invention is to provide an inexpensive, rugged and easily usable device that extends the effective range of a patient support arm.

A further object of the invention is to provide an extension device for a patient boom support arm which is easily attachable to a patient support arm of a patient lifting device and which is adjustable.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of a boom extension attached to a support arm and deployed in combination with a patient lift harness.

FIG. 2 is an isometric view of the embodiment of FIG. 1 from the opposite side of the patient lifting mechanism;

FIG. 3 is a partial isometric view of a boom extension attached to a support arm in combination with a patient sling;

FIG. 4 is an isometric view of the combination of FIG. 3 depicting the manner of support of a person or patient to be placed in a vehicle;

FIG. 5 is an isometric view of the device depicted in FIG. 4 wherein a person or patient has been placed on a vehicle seat by operation of the device; and

FIG. 6 is an exploded isometric view of the boom extension utilized in FIGS. 1-5.

### DESCRIPTION OF THE PREFERRED EMBODIMENT

Referring to the figures, the present patient lift extension 10 includes left and right bars 12, 13 that are attached to a patient support boom arm 16 of a lift 18. Various prior art references previously referenced disclose various lifts 18. The boom arm 16 of a patient lift device 18 typically extends in an upward diagonal direction with a downward curvature; however, the particular configuration of the arm 16 is not a limiting feature of the invention. That is, the extension 10 increases the height and length of the boom arm 16. The extension 10 of the present invention is easily attached to the boom arm 16 by only two bolts 20, 22.

The bars 12, 13 are positioned on opposing sides of the boom arm 16 and preferably have ends 47, 48 that diverge outwardly from each other. The bars 12, 13 are secured to the boom arm 16 by means of cooperation with the bolts 20, 22 extending through each of the bars 12, 13 and secured in place by suitable nuts 15, 17. The bolts 20, 22 preferably do not extend through the boom arm 16, thereby making attachment of the extension 10 to an existing lift system 18 easy.

As illustrated in the drawings, the first bolt 20 extends beneath the boom arm 16 while the second bolt 22 extends above the boom arm 16. When the bolts 20, 22 are tightened, the bars 12, 13 are both secured to the boom 16 through frictional attachment, and also the bolt 20 fits against the underside of the boom arm 16 and as the bolt 22 fits against a top side of the boom 16. The positioning of the bolts 20, 22 as described retains the extension 10 in place when a downward force (weight of patient)is exerted on the bars 12, 13. It should be understood that although a curved boom 16 arm is illustrated, the manner in which the bars 12, 13 are secured in position on the boom arm 16 can also be used on a boom arm 16 that is straight and not curved.

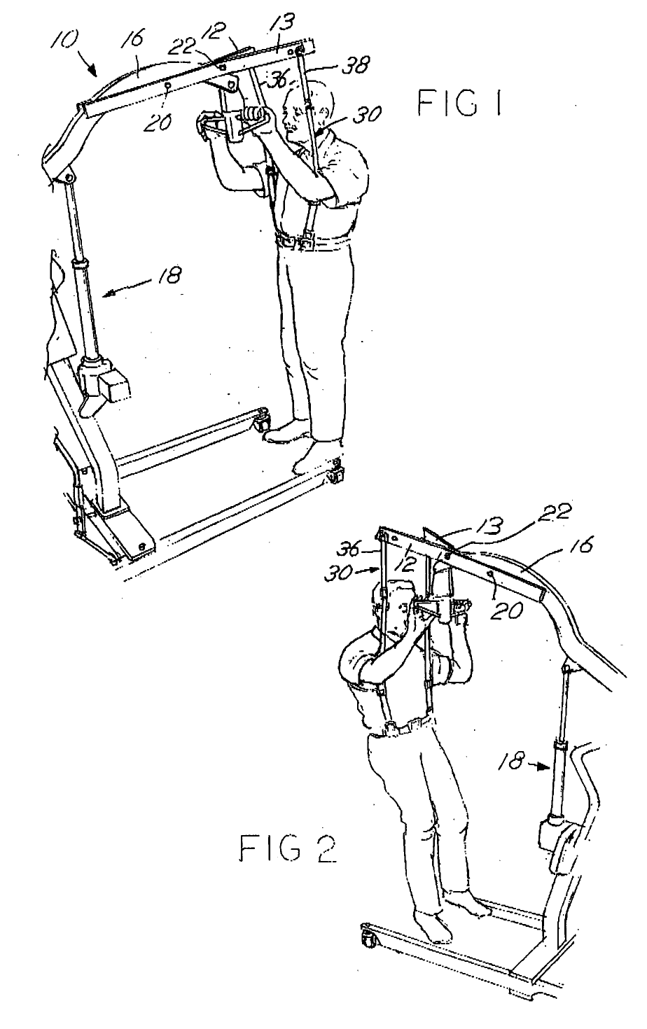

The diverging outer ends 47, 48 of bars 12, 13 include apertures 27, 29 or hooks 23, 25 at distal end portions for securing a lift harness 30. In FIGS. 1 and 2, a strap-type lift harness 30 is illustrated. In drawings 3-5, a sling-type harness 32 is illustrated.

As illustrated in FIGS. 1 and 2, a patient is secured within a strap-type lift harness 30 that is used as a walker assist device. Straps 36, 38 extending upwardly from the harness 30 are attached to the ends of bars 12, 13. The extension 10 provides an existing lift device 18 with a means for extension of the boom arm 16 to convert the lift device 18 to a walker assist device.

The apertures, 27, 29 in the bars 12, 13 at their distal ends provide a point of attachment for the straps 36, 38 that extend upwardly from a harness 30.

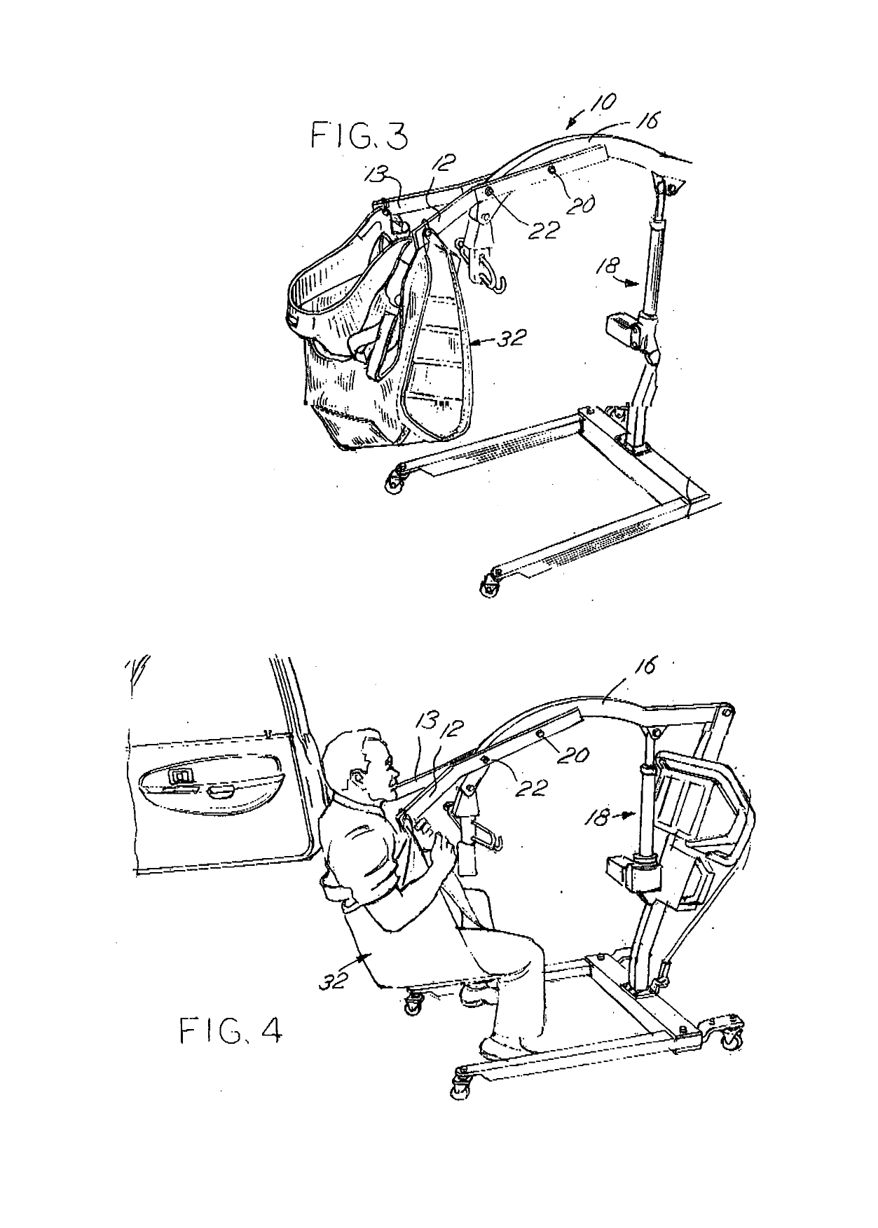

As illustrated in FIGS. 3-5, a sling 32 in which the patient sits is attached to the distal ends of bars 12, 13. The sling 32 is used to assist moving a seated patient in a sling 32 into and out of a vehicle. As illustrated in FIG. 4, the patient is positioned in the sling 32 in a sitting position prior to entry in the vehicle.

In FIG. 5, the patient is shown still in the sling 32 and positioned over the seat within the interior of the vehicle. The extension 10 provides an extension to the boom arm 16 sufficient for the person to be placed over the vehicle seat. Once the patient is positioned within the interior of the vehicle and over the vehicle seat, the sling 32 may be detached from the lift device. Since the patient is on the vehicle seat, there is no danger of the patient being injured and there is no danger of the healthcare worker being injured since the healthcare worker is not supporting the patient in an awkward position during the transfer into or out of the vehicle.

The lift device 18 can also be used in its originally intended manner by simply removing the nuts 15, 17 from engagement with the bolts 20, 22 to detach the bars 12, 13 from the boom arm 16. The present invention provides a simple and easy manner of extending the lifting capabilities of an existing patient lift.

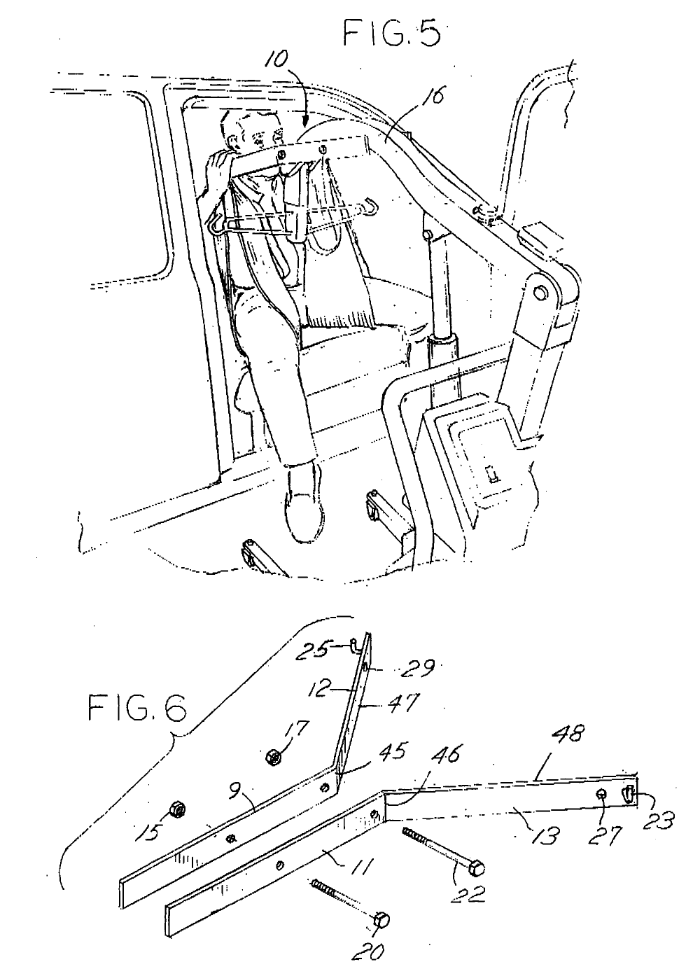

Referring to FIG. 6, as is noted that the bars or extension members 12, 13 are fabricated from flat bar stock wherein internal or interior section of each of the bars 12, 13 namely the interior sections 9, 11 are arranged or arrayed so that they are parallel to one another and connect via respective bends in the flat stock, for example, bends 45, 46 to bifurcated arms 47, 48. The outer ends of the bifurcated arms 47, 48 are spaced from one another a distance approximately equal to the width of the shoulders of a patient. This enables use of harness systems designed for support of patient of the type typically used with patient lift devices 18. Although flat bar stock may be used, other shapes and configurations of stock may be utilized in the practice of the invention.

In the practice of the invention, the boom extension 10 comprises a cantilever extension of the boom arm 16. The mechanism for attaching the extension 10 to the arm 16 may be varied. For example, pins may be utilized. Additionally, the boom arm 16 may be slightly modified by including notches which serve as detents for the bolts 20, 22 to retain the extension 10 and preclude the extension 10 from slipping forwardly or backwardly once attached to the boom arm 16. The extension 10 may also be curvilinear. The bifurcated sections 47, 48 may be curved upwardly or downwardly.

Although the present invention has been described with reference to preferred embodiments, workers skilled in the art will recognize that changes may be made in form and detail without departing from the spirit and scope of the invention.

What is claimed is:

1. An extension device for a patient lift apparatus comprising, in combination:
first and second elongate bars having an inner end and an outer end, said bars arrayed side by side and having an inner section and an outer extension section, said inner section configured to fit over a boom arm of a patient lift device and including at least a first fastener for attaching the bars together, said first fastener being spaced from a second connection member connecting the bars, one of said first fastener or connection member positioned inwardly from the outer end of the bars to engage an underside of a boom arm as the other engages a top side; and
a harness attachment mechanism located at the outer ends of the bars, said bars providing a cantilever extension for a boom arm.

2. The device of claim 1 in combination with a patient lift device having a patient support boom arm.

3. The device of claim 2 in combination with a patient harness attached to the outer ends of the bars.

4. The device of claim 1 in combination with a patient harness attached to the outer ends of the bars.

5. The device of claim 1 wherein the outer ends are spaced from each other by a distance greater than the inner section.

6. The device of claim 2 wherein the inner section is, at least in part, frictionally engaged with the boom arm.

7. The device of claim 1 wherein the second member is a fastener for attaching the bars together.
